(19) United States
(12) Patent Application Publication
(10) Pub. No.: US 2014/0185194 A1
(43) Pub. Date: Jul. 3, 2014

(54) PLUG-IN COMPOSITE POWER DISTRIBUTION ASSEMBLY AND SYSTEM INCLUDING SAME

(71) Applicants: Patrick Wellington Mills, Bradenton, FL (US); James Michael McCormick, Bradenton, FL (US)

(72) Inventors: Patrick Wellington Mills, Bradenton, FL (US); James Michael McCormick, Bradenton, FL (US)

(73) Assignee: EATON CORPORATION, CLEVELAND, OH (US)

(21) Appl. No.: 14/119,300

(22) PCT Filed: May 17, 2012
(86) PCT No.: PCT/US2012/038340

§ 371 Date: Nov. 21, 2013

Related U.S. Application Data
(60) Provisional application No. 61/491,466, filed on May 31, 2011.

(51) Int. Cl. H02B 1/56

(52) U.S. Cl. CPC H02B 1/565
USPC 361/624; 361/622

(57) ABSTRACT

A power distribution assembly is provided for a system such as, for example, an aircraft electrical system. The power distribution assembly includes a frame having a number of mounting points structured to be mounted to a thermally conductive structure such as, for example, an aircraft panel. A shell is disposed on the frame. A backplane is disposed within the shell. The backplane includes a plurality of at least partially embedded electrical conductors. Electrical apparatus such as, for example, relays or contactors, are electrically connected to the at least partially embedded electrical conductors. The relays or contactors generate heat. The backplane, the at least partially embedded electrical conductors, and the frame provide a direct thermal pathway for transferring the heat away from the power distribution assembly to the aircraft panel.

### CROSS-REFERENCE TO RELATED APPLICATION

This application claims the benefit of U.S. Provisional Patent Application Ser. No. 61/491,466, filed May 31, 2011, entitled “PLUG-IN COMPOSITE POWER DISTRIBUTION ASSEMBLY AND SYSTEM INCLUDING SAME,” which is incorporated by reference herein.

### BACKGROUND

1. Field

The disclosed concept pertains generally to power distribution assemblies and, more particularly, to power distribution assemblies such as, for example, plug-in composite power distribution assemblies. The disclosed concept also relates to systems including power distribution assemblies.

2. Background Information

Aircraft or aerospace electrical systems generate, regulate and/or distribute power throughout an aircraft.

Aerospace power distribution assemblies, for example, generally include an enclosure, a number of input and output connectors, internal electrical bussing, electrical conductors, a number of electrical switching apparatus, such as contactors, circuit breakers, relays and the like and/or fuses. More specifically, in aircraft or aerospace electrical systems relatively small circuit breakers, commonly referred to as subminiature or aircraft circuit breakers, are often used to protect electrical circuitry from damage due to an overcurrent condition, such as an overload condition or a relatively high level short circuit or fault condition. Aircraft circuit breakers also often serve as switches for turning equipment on and off, and are grouped together as part of a circuit protection module with the circuit breakers/switches being accessible on an outer panel of the enclosure, within the aircraft.

Within the enclosure, a backplane made of melamine or a suitable thermoset compound is typically employed to meet dielectric insulation requirements and suitably separate and isolate the electrical components. However, significant heat is generated in aircraft electrical systems, which increases resistivity and adversely affects system performance. While the melamine or thermoset material of the backplane generally serves well as an effective electrical insulator, it is thermally insulative and, therefore, prevents good heat transfer to free air or the aircraft structure. Accordingly, among other disadvantages, known power distribution assemblies and systems require substantial use of point-to-point electrical conductors (e.g., wires), relatively significant spacing between bus bars, and/or electrically insulative coating, and/or the use of a fans to reduce heat.

There is room for improvement in power distribution assemblies, and in systems including power distribution assemblies.

### SUMMARY

These needs and others are met by embodiments of the disclosed concept, which are directed to a power distribution assembly and system including same. Among other benefits, the power distribution assembly provides effective heat transfer within a relatively light and compact structure.

As one aspect of the disclosed concept, a power distribution assembly is provided for an electrical system. The power distribution assembly comprises: a frame including a number of mounting points structured to be mounted to a thermally conductive structure; a shell disposed on the frame; a backplane disposed within the shell, the backplane comprising a plurality of at least partially embedded electrical conductors; and a plurality of electrical apparatus electrically connected to the at least partially embedded electrical conductors. The electrical apparatus generate heat. The backplane, the at least partially embedded electrical conductors, and the frame are structured to provide a direct thermal pathway for transferring the heat away from the power distribution assembly to the thermally conductive structure.

The plurality of at least partially embedded electrical conductors may comprise a plurality of electrical buss members, and the backplane may further comprise a plurality of electrical connectors, wherein the electrical connectors are electrically connected to the electrical buss members. The plurality of electrical apparatus may comprise a number of contactors or relays each being electrically connected to a corresponding set of the electrical connectors.

The backplane may be thermally conductive and electrically insulative, to facilitate heat transfer and to electrically insulate the electrical buss members. The frame, the shell, and the backplane may be mechanically connected together, thereby providing the direct thermal pathway to the thermally conductive structure. The backplane may further comprise a plurality of fasteners, wherein the fasteners fasten and thermally connect the backplane to the shell and the frame.

The shell may further comprise a first side, a second side disposed opposite and distal from the first side, and a panel removably coupled to the first side. The panel may comprise a plurality of circuit breakers, and the backplane may further comprise a circuit breaker interface. The circuit breakers may be electrically connected to the circuit breaker interface.

As another aspect of the disclosed concept, a system comprises: a thermally conductive structure; and a power distribution assembly comprising: a frame including a number of mounting points for mounting the frame to the thermally conductive structure, a shell disposed on the frame, a backplane disposed within the shell, the backplane comprising a plurality of at least partially embedded electrical conductors, and a plurality of electrical apparatus electrically connected to the at least partially embedded electrical conductors. The electrical apparatus generate heat. The backplane, the at least partially embedded electrical conductors, and the frame provide a direct thermal pathway for transferring the heat away from the power distribution assembly to the thermally conductive structure.

The system may be an aircraft electrical system, the power distribution assembly may be an aircraft power distribution unit for the aircraft electrical system, and the thermally conductive may be an aircraft panel.

### BRIEF DESCRIPTION OF THE DRAWINGS

A full understanding of the disclosed concept can be gained from the following description of the preferred embodiments when read in conjunction with the accompanying drawings in which:

FIG. 1 is an isometric view of a power distribution assembly and electrical system, in accordance with an embodiment of the disclosed concept;

FIG. 2 is a top plan view of the power distribution assembly and system of FIG. 1, also showing various electrical connection options in accordance with one non-limiting embodiment of the disclosed concept;

FIGS. 3 and 4 are side and end elevation views, respectively, of the power distribution assembly and system of FIG. 2;

FIG. 5 is a back plan view of the power distribution assembly of FIG. 4;

FIG. 6 is a top plan view of the power distribution assembly of FIG. 5, with the cover removed to show internal components;

FIG. 7 is an isometric view of the power distribution assembly of FIG. 6;

FIG. 8 is an isometric view of the backplane of FIG. 7;

FIGS. 9 and 10 are top plan views of the backplane of FIG. 8, with electrical apparati removed and electrical buss members shown in hidden line drawing in FIG. 10;

FIG. 11 is a side elevation partially in section view of a portion of the backplane of FIG. 10, also showing a portion of the frame; and

FIG. 12 is a section view taken along line 12-12 of FIG. 9.

### DESCRIPTION OF THE PREFERRED EMBODIMENTS

For purposes of illustration, the disclosed concept is described herein in association with aircraft or aerospace power distribution assemblies and systems employing subminiature or aircraft circuit breakers and other electrical apparatus (e.g., without limitation, relays; contactors), although it will become apparent that the disclosed concept is applicable to a wide range of different applications. For example and without limitation, the disclosed concept can be employed in aircraft alternating current (AC) systems having a typical frequency of about 400 Hz, but can also be used in direct current (DC) systems. It will also become evident that the disclosed concept is applicable to other types of electrical systems including, for example and without limitation, circuit breaker panels or circuit protection modules used in AC systems operating at other frequencies; to larger circuit breakers, such as miniature residential or commercial circuit breakers; and to a wide range of circuit breaker applications, such as, for example, residential, commercial, industrial, aerospace, and automotive.

As employed herein, the term “fastener” refers to any suitable connecting or tightening mechanism expressly including, but not limited to, rivets, pins, screws, bolts and the combinations of bolts and nuts (e.g., without limitation, lock nuts) and bolts, washers and nuts.

As employed herein, the term “electrical conductor” shall mean a wire (e.g., solid; stranded; insulated; non-insulated), an electrical buss member, a pin, a connector, a copper conductor, an aluminum conductor, a suitable metal conductor, or other suitable material or object that permits an electric current to flow easily.

As employed herein, the term “embedded” shall mean disposed within a material so as to be integrally formed within, surrounded by, or covered by the material. Accordingly, unless explicitly stated otherwise, an electrical conductor that is “at least partially embedded” in accordance with the disclosed concept may be either entirely embedded (e.g., integrally formed within; surrounded by; covered by) within the material, or a portion of the electrical conductor may protrude outwardly from the material.

As employed herein, the term “liquid crystalline polymer” shall mean a moldable (e.g., without limitation, by injection molding) material that is both thermally conductive and electrically non-conductive (e.g., an electrical insulator) exhibiting dielectric properties and expressly includes, but is not limited to, CoolPoly® D5506, which is available from Cool Polymers, Inc. having a place of business at 51 Circuit Drive, North Kingstown, R.I. 02852.

As employed herein, the term “managed” or “manages” shall mean handled or directed with a degree of skill, worked upon or tired to alter for a purpose, or succeeded in accomplishing or achieved a purpose.

As employed herein, the statement that two or more parts are “connected” or “coupled” together shall mean that the parts are joined together either directly or joined through one or more intermediate parts. Further, as employed herein, the statement that two or more parts are “attached” shall mean that the parts are joined together directly.

As employed herein, the term “number” shall mean one or an integer greater than one (i.e., a plurality).

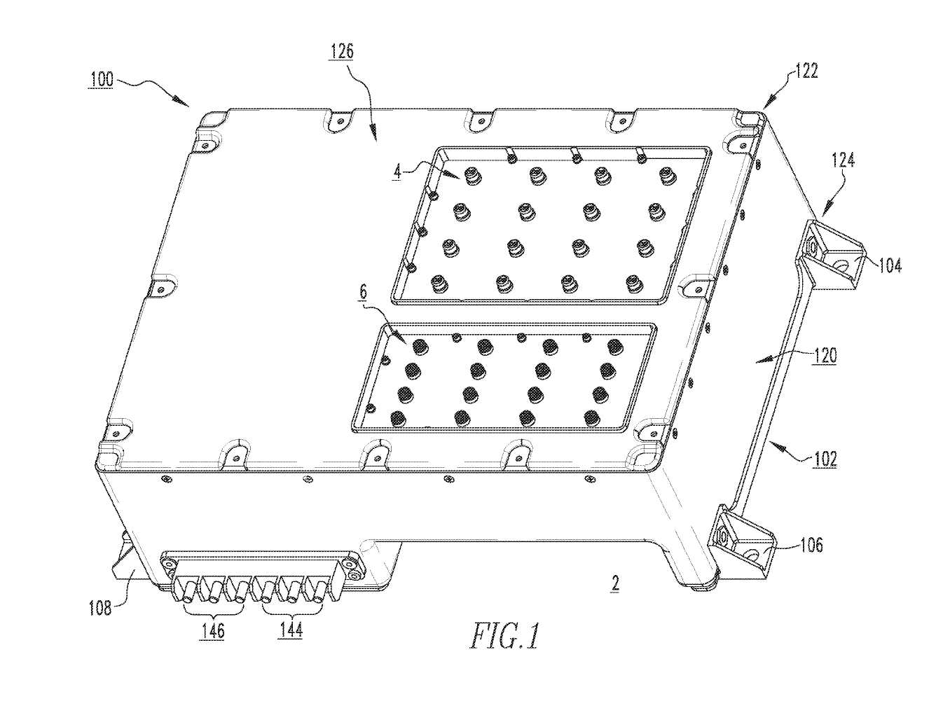

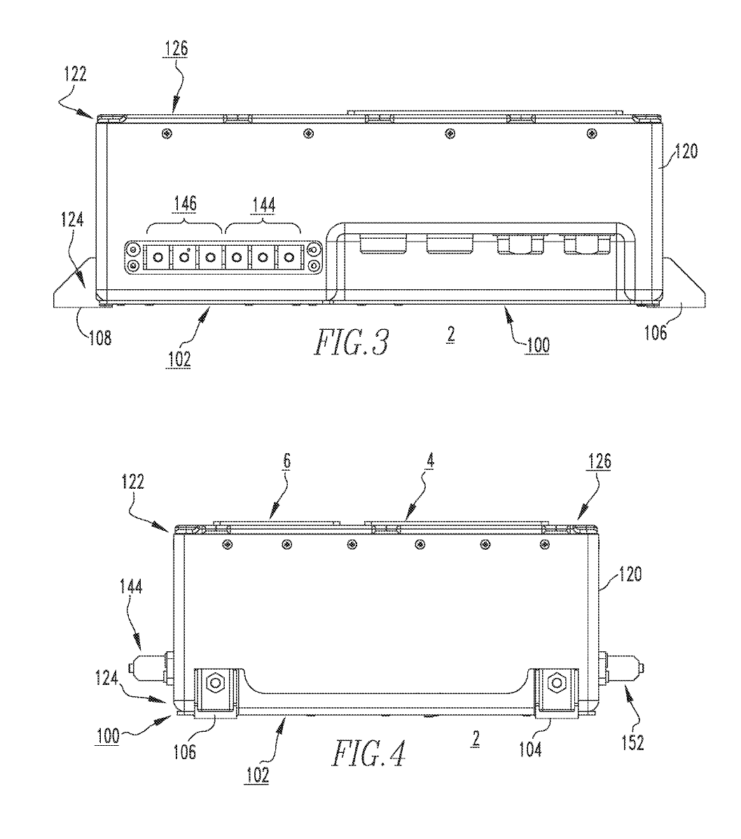

Referring now to the drawings, which are not intended to limit the scope of the disclosed concept, FIGS. 1-7 illustrate a power distribution assembly 100 according to an embodiment of the disclosed concept. Although not limited thereto, the illustrated embodiment of the disclosed concept is particularly suited for use in an aerospace (e.g., aircraft) power distribution system 2 (FIGS. 1-4 and 11).

As will be described hereinbelow, the disclosed concept is a power distribution assembly 100 that utilizes, among other features, an embedded plug-in circuit breaker arrangement. In one non-limiting embodiment, the power distribution assembly 100 includes a mounting spine or frame 102, a shell 120, and a backplane 130. Among other benefits, this composite structure is relatively lightweight, yet provides a relatively high strength enclosure to mount/support the plug-in circuit breaker cover assembly. The embodiment shown in the drawings is configured as a three-phased AC system; however, other configurations may be used, including, without limitation, a single-phase DC configuration (not shown).

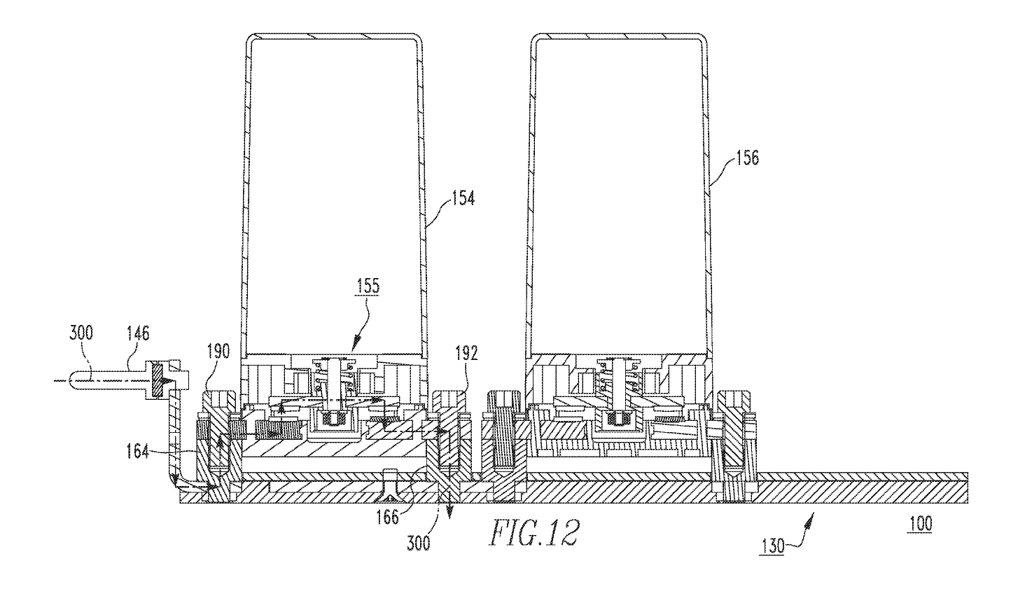

As shown in FIG. 1, the mounting spine or frame 102 is connected to the shell 120. In one non-limiting embodiment, the frame 102 is made of aluminum and the shell 120 is made of carbon fiber; however, in both cases use of these materials is not intended to be limited thereto. When using carbon fiber, the carbon fiber composition may include, for example, EMI shielding materials and conductive nano-particles to impart specific electrical and/or physical properties. In an aircraft application, the shell 120 may include at least one connector that provides the power distribution assembly 100 in electrical communication with one or more other systems, such as a cockpit circuit breaker panel (not shown). The mounting frame 102 may be bonded and mechanically interlocked to the shell 120 and backplane 130, providing a direct thermal pathway 300 (FIGS. 11 and 12) to an adjacent thermally conductive structure 200 (e.g., without limitation, see aircraft structure partially shown in FIG. 11), without compromising safety.

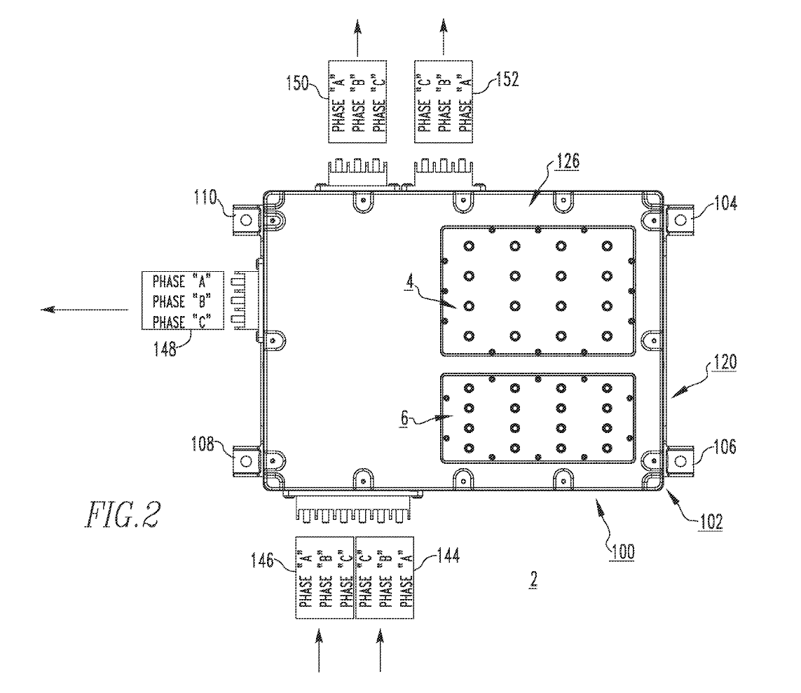

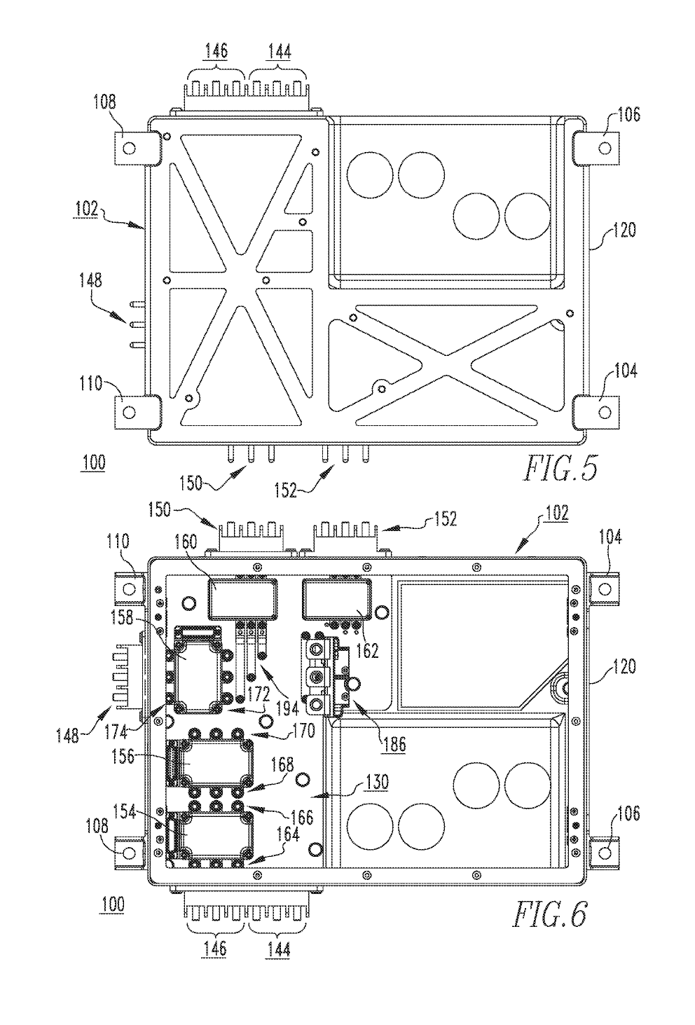

The plug-in circuit breakers 4,6 (FIGS. 1 and 2) are mounted to a cover or panel 126 of the shell 120, and/or the electrical apparatus (e.g., without limitation, relays or contactors 154,156,158,160,162 (all shown in FIGS. 6-8 and 9) are mounted to the backplane 130 using, for example, the invention described in U.S. patent application Ser. No. 12/748,639, filed on Mar. 29, 2010, which is assigned to Eaton Corporation. The plug-in circuit breakers 4,6 (partially shown in FIG. 1) may be installed on the cover or panel 126 using the pins, shown in FIG. 1. This configuration allows the plug-in circuit breakers 4,6 to be incorporated into the power distribution assembly 100, eliminating point to point wiring. This configuration also allows a thermally managed circuit breaker panel 126 to be incorporated within the power distribution assembly 100. The described configuration also provides ease of maintenance to replace a circuit breaker 4,6 and access to internal components (e.g., without limitation, contactors; current sensing module; electronics line replaceable units (LRUs)). While a pin and socket arrangement is employed in the illustrated embodiment, other plug-in configurations may also be used, including, without limitation, flying leads, pig tails and edge connectors, without departing from the scope of the disclosed concept.

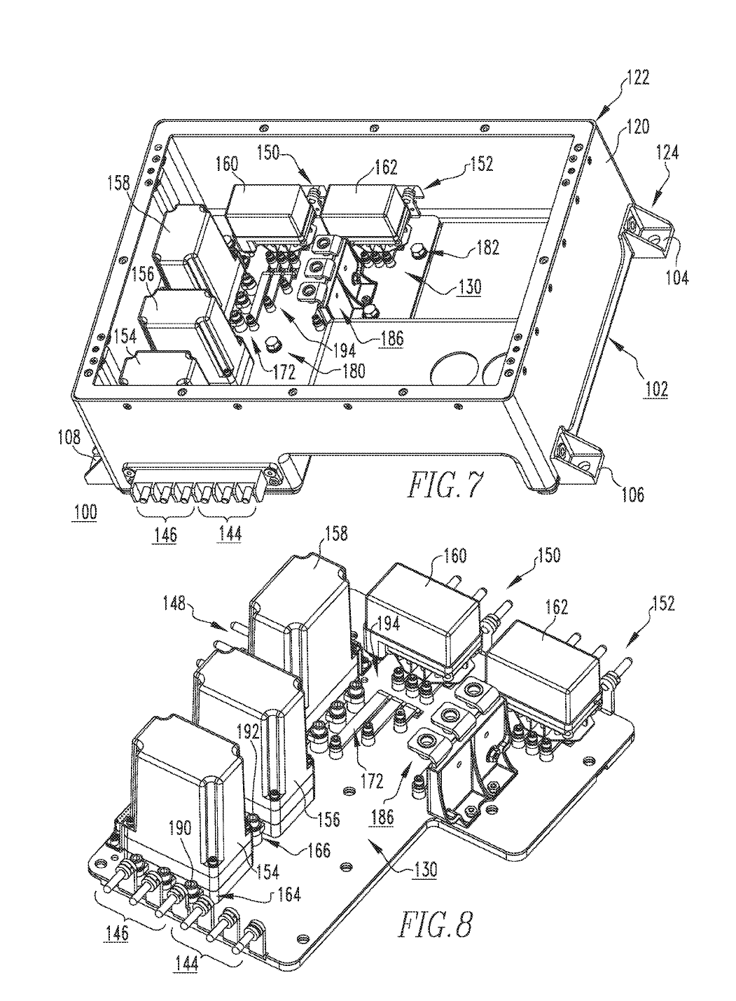

As shown in FIGS. 1, 3, 4 and 7, the example shell 120 includes a first side 122 and a second side 124 disposed opposite and distal from the first side 122. The aforementioned cover or panel 126 is removably coupled to the first side, as shown in FIG. 1. It will be appreciated that the shell 120 is preferably disposed on, and connect to, the frame 102, as best shown in FIGS. 6 and 7.

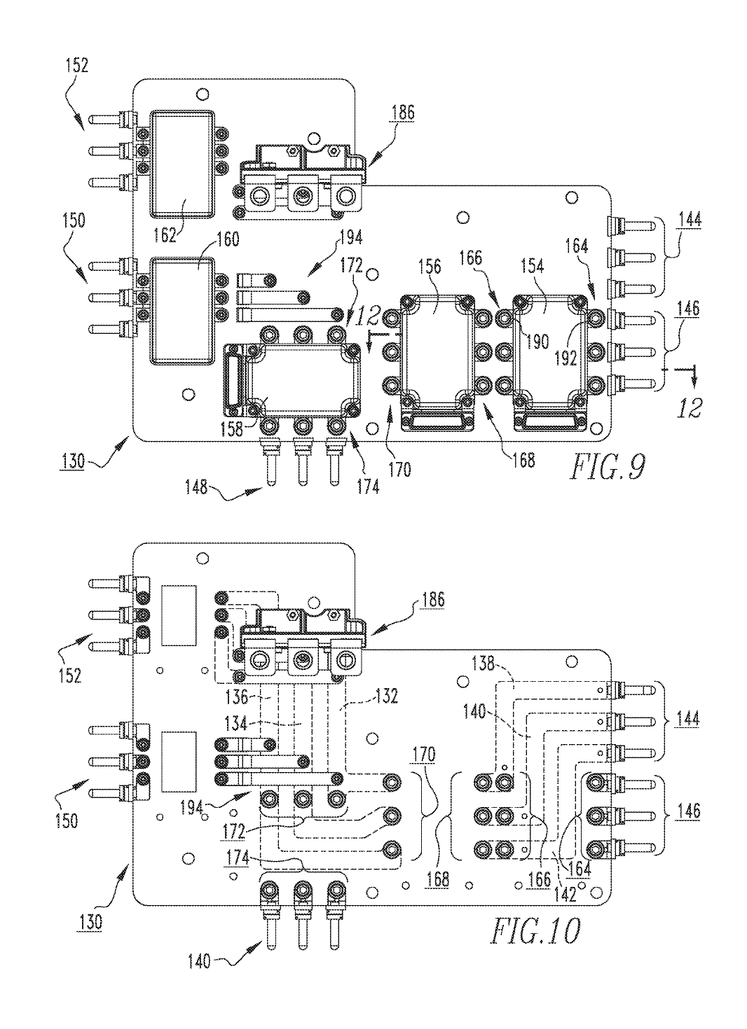

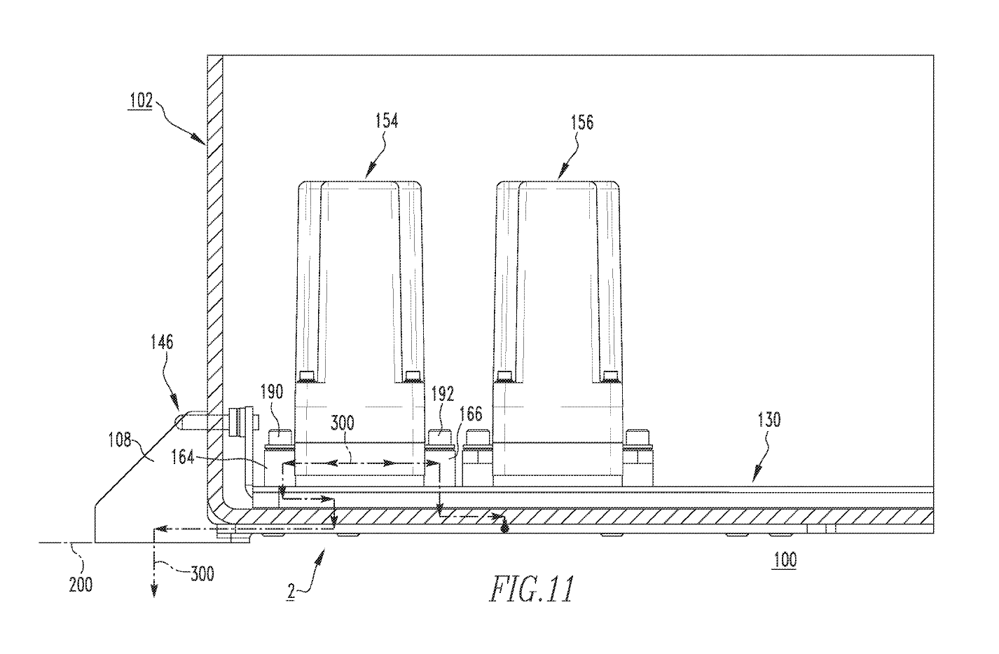

The backplane 130 is disposed within the shell 120 and includes a plurality of at least partially embedded electrical conductors 132,134,136,138,140,142,144,146,148,150,152 (best Shown in FIG. 10). The electrical apparati (see, for example and without limitation, contactors or relays 154,156,158,160,162 of FIGS. 6, 8 and 9) are electrically connected to the at least partially embedded electrical conductors 132,134,136,138,140,142,144,146,148,150,152, as best shown in the top plan views of FIGS. 6 and 9. As will be discussed in greater detail hereinbelow, the electrical apparati and, in particular, relays 154,156,158 generate a relatively significant amount of heat (e.g., up to 90 percent, or more, of the heat in the power distribution assembly 100). Accordingly, as noted hereinabove, the unique structure of the disclosed frame 102, shell 120 and backplane 130 provide a direct thermal pathway 300 for transferring the heat away from the power distribution assembly 100 to the aircraft structure 200 (partially shown in FIG. 11), as shown in FIGS. 11 and 12.

More specifically, in the example of FIG. 10, electrical buss members 132,134,136,138,140,142 (shown in hidden line drawing) mount the contactors or relays (e.g., 154,156,158), and provide the direct thermal pathway 300 to the thermally conductive structure 200 (FIG. 11) to which the power distribution assembly 100 is mounted (e.g. aluminum panel 200 in aerospace applications). This approach encapsulates and protects the electrical buss members 132,134,136,138,140,142 (e.g., power buss bars) particularly when compared to more conventional configurations that require larger buss bar spacing and dielectric powder coating. In other words, being at least partially embedded in the backplane 130 protects electrical components from shorts and dielectric breakdown. The electrical buss members 132,134,136,138,140,142 are also in intimate contact with the thermally conductive backplane 130 for superior heat transfer to the mounting frame 102 and onto the aircraft structure 200. The example frame 102 has a plurality of mounting points 104,106,108,110 (four are shown in FIGS. 2, 5 and 6). The backplane 130 is also electrically insulative. This improvement saves weight, decreases overall package size and significantly reduces assembly labor. In one non-limiting embodiment, the backplane 130 is made from CoolPoly® D5506, which is a thermally conductive, electrically resistive material. It will be appreciated that other thermally conductive, electrically insulative materials may also be used, such as, for example, liquid crystal polymer utilizing a thermal doping compound.

Referring to FIGS. 9 and 10, it will be appreciated that the example backplane 130 further includes a plurality of electrical conductors in the form of pins 144,146,148,150,152 electrically connected to the buss members 132,134,136,138,140,142 (shown in hidden line drawing in FIG. 10). The backplane 130 also includes electrical connectors 164,166,168,170,172,174, which electrically connect the aforementioned electrical apparati (see, for example and without limitation, contactors or relays 154,156,158,160,162 of FIG. 9) to corresponding electrical buss members 132,134,136,138,140,142 (FIG. 10).

As shown in FIGS. 11 and 12, with reference to relay 154, the relay 154 is mechanically coupled and thermally connected to the frame 102 and backplane 130 by electrical connectors 164,166, which in the non-limiting example shown and described herein are copper lugs. The copper lugs 164,166 extend into the backplane 130 and receive fasteners 190,192, respectively, for fastening the relay 154 to the backplane 130 and, in turn, thermally connecting it to the backplane 130, the frame 102, and the aircraft structure 200 (partially shown in phantom line drawing in FIG. 11). In this manner, the aforementioned direct thermal pathway 300 for removing heat from the power distribution assembly 100, is provided.

Specifically, the thermal pathway 300 is shown in FIGS. 11 and 12. As shown in FIG. 11, heat generated by the contact assembly 155 (shown in the section view of FIG. 12) of the relay 154 exits through the aforementioned copper lugs 164,166 and fasteners 190,192, into the backplane 130, to the frame 102, and ultimately out through the mounting point 108 of the frame 102 to the aircraft structure 200. Thus, the heat is effectively managed, without requiring a separate cooling device or assembly (e.g., without limitation, plenum; powder coating; a fan assembly (not shown)). Additionally, because of the thermally conductive and electrically insulative nature of the backplane 130, the design can remain relatively small (e.g., compact) and lightweight.

FIG. 12 shows the direct thermal pathway 300 from a different perspective. That is, the heat associated with the electrical current is shown flowing through pin 146, into and through copper lug 164 and associated fastener 190, into the contact assembly 155 of relay 154, where relatively significant heat is generated and sent back out of the relay 154, as shown and described hereinabove with respect to FIG. 11, and as shown passing into and through fastener 192 and copper lug 166, and the backplane 130.

The disclosed power distribution assembly 100 also preferably includes a floating floor configuration to address the coefficient of thermal expansion difference between the different materials of the backplane 130, the aluminum frame 102 and the carbon fiber shell 120.

For example and without limitation, as shown in FIG. 7, the backplane 130 is fastened to the frame 102 by a plurality of fasteners 180,182. The floating floor configuration, therefore, may consist of a suitable sizing and configuration of openings, fasteners (e.g., without limitation, 180,182) and fastening locations among the frame 102, shell 120, backplane 130 and fasteners (e.g., without limitation 180,182) to accommodate the differences in thermal expansion among the different materials of these different components. For example, the backplane 130 may include a through hole for each fastener 180,182 that is sufficient in size to accommodate thermal expansion of the fasteners 180,182 and/or backplane 130 with respect to the frame 102 and/or shell 120 while sufficiently securing the assembly together.

The thermally conductive carbon fiber shell 120 provides a lightweight and relatively rigid structure that can be mounted directly to the aircraft structure 200 (FIG. 11). In one non-limiting embodiment, the shell 120 includes a sub-floor of thermally conductive injection molding grade thermoplastic (e.g., CoolPoly® D5506). Buss bars or Printed Circuit Board (PCB) heavy trace may also be embedded in channels in the sub-floor, as previously described and shown in hidden line drawing in FIG. 10. The PCB (e.g., signal relay control traces only) may be bonded to the backplane 130 to reduce the number of required fasteners and to increase overall component and assembly rigidity.

In the embodiment illustrated in FIGS. 6-10, the backplane 130 also includes a circuit breaker interface 186 and an installed current sensor 194 that may be attached to the backplane 130 as a module. The current sensor 194 may be configured to provide phase imbalance or individual conductor measurement and may be capable of acting as a resettable fuse for supplemental protection. Alternatively, other current sensors may be employed in the assembly, including, without limitation, Hall effect and shunt current sensors (not shown). The circuit breaker interface 186 provides a suitable electrical connection, for example, for the aforementioned circuit breakers 4,6 (FIGS. 1 and 2)).

It is believed that various alterations and modifications of the disclosed concept will become apparent to those skilled in the art from a reading and understanding of the specification. It is intended that all such alterations and modifications are included in the disclosed concept, insofar as they come within the scope of the appended claims.

While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed concept which is to be given the full breadth of the claims appended and any and all equivalents thereof.

What is claimed is:

1. A power distribution assembly for an electrical system, said power distribution assembly comprising:
a frame including a number of mounting points structured to be mounted to a thermally conductive structure;
a shell disposed on said frame;
a backplane disposed within said shell, said backplane comprising a plurality of at least partially embedded electrical conductors; and
a plurality of electrical apparatus electrically connected to said at least partially embedded electrical conductors,
wherein said electrical apparatus generate heat, and
wherein said backplane, said at least partially embedded electrical conductors, and said frame are structured to provide a direct thermal pathway for transferring said heat away from said power distribution assembly to said thermally conductive structure.

2. The power distribution assembly of claim 1 wherein said plurality of at least partially embedded electrical conductors comprises a plurality of electrical buss members; wherein said backplane further comprises a plurality of electrical connectors; and wherein said electrical connectors are electrically connected to said electrical buss members.

3. The power distribution assembly of claim 2 wherein said plurality of electrical apparatus comprises a number of contactors or relays each being electrically connected to a corresponding set of said electrical connectors.

4. The power distribution assembly of claim 2 wherein said backplane is thermally conductive and electrically insulative to facilitate heat transfer and to electrically insulate said electrical buss members.

5. The power distribution assembly of claim 1 wherein said frame, said shell, and said backplane are mechanically connected together, thereby providing said direct thermal pathway to said thermally conductive structure.

6. The power distribution assembly of claim 5 wherein said backplane further comprises a plurality of fasteners; and wherein said fasteners fasten and thermally connect said backplane to said shell and said frame.

7. The power distribution assembly of claim 1 wherein said shell comprises a first side, a second side disposed opposite and distal from the first side, and a panel removably coupled to the first side; wherein said panel comprises a plurality of circuit breakers; wherein said backplane further comprises a circuit breaker interface; and wherein said circuit breakers are electrically connected to said circuit breaker interface.

8. A system comprising:
a thermally conductive structure; and
a power distribution assembly comprising:
a frame including a number of mounting points for mounting said frame to said thermally conductive structure,
a shell disposed on said frame,
a backplane disposed within said shell, said backplane comprising a plurality of at least partially embedded electrical conductors, and
a plurality of electrical apparatus electrically connected to said at least partially embedded electrical conductors,
wherein said electrical apparatus generate heat, and
wherein said backplane, said at least partially embedded electrical conductors, and said frame provide a direct thermal pathway (300) for transferring said heat away from said power distribution assembly to said thermally conductive structure.

9. The system of claim 8 wherein said plurality of at least partially embedded electrical conductors comprises a plurality of electrical buss members; wherein said backplane further comprises a plurality of electrical connectors; and wherein said electrical connectors are electrically connected to said electrical buss members.

10. The system of claim 9 wherein said plurality of electrical apparatus comprises a number of contactors or relays each being electrically connected to a corresponding set of said electrical connectors.

11. The system of claim 9 wherein said backplane is thermally conductive and electrically insulative to facilitate heat transfer and to electrically insulate said electrical buss members.

12. The system of claim 8 wherein said frame, said shell, and said backplane are mechanically connected together, thereby providing said direct thermal pathway to said thermally conductive structure.

13. The system of claim 12 wherein said backplane further comprises a plurality of fasteners; and wherein said fasteners fasten and thermally connect said backplane to said shell and said frame.

14. The system of claim 8 wherein said shell comprises a first side, a second side disposed opposite and distal from the first side, and a panel removably coupled to the first side; wherein said panel comprises a plurality of circuit breakers; wherein said backplane further comprises a circuit breaker interface; and wherein said circuit breakers are electrically connected to said circuit breaker interface.

15. The system of claim 8 wherein said system is an aircraft electrical system; wherein said power distribution assembly is an aircraft power distribution unit for said aircraft electrical system; and wherein said thermally conductive structure is an aircraft panel.
